(19) United States
(12) Patent Application Publication
(10) Pub. No.: US 2024/0331901 A1
(43) Pub. Date: Oct. 3, 2024

(54) INSULATOR-COATED SOFT MAGNETIC POWDER, MAGNETIC POWDER CORE, MAGNETIC ELEMENT, AND ELECTRONIC DEVICE

(71) Applicant: SEIKO EPSON CORPORATION, TOKYO (JP)

(72) Inventor: Momoko WAKABAYASHI, Hachinohe-shi (JP)

(21) Appl. No.: 18/617,094

(22) Filed: Mar. 26, 2024

(30) Foreign Application Priority Data
Mar. 28, 2023 (JP) 2023-051107

(51) Int. Cl. H01F 1/20; H01F 27/255

(52) U.S. Cl. CPC H01F 1/20; H01F 27/255

(57) ABSTRACT

An insulator-coated soft magnetic powder includes a soft magnetic powder, an inorganic insulating film including a ceramic and covering the particle surface of the soft magnetic powder, and an organic film including a compound derived from a coupling agent having a hydrophobic functional group and covering the surface of the inorganic insulating film, wherein the inorganic insulating film has an average thickness of from 5 nm to 100 nm, and the insulator-coated soft magnetic powder has a water content of from 30 ppm to 400 ppm, as measured by the Karl Fischer method at 250° C. after the insulator-coated soft magnetic powder is left in an environment of atmospheric pressure, a temperature of 30° C., and a relative humidity of 80% for 24 hours.

The present application is based on, and claims priority from JP Application Serial Number 2023-051107, filed Mar. 28, 2023, the disclosure of which is hereby incorporated by reference herein in its entirety.

### BACKGROUND

### 1. Technical Field

The present disclosure relates to an insulator-coated soft magnetic powder, a magnetic powder core, a magnetic element, and an electronic device.

### 2. Related Art

JP 2022-060995 A discloses a soft magnetic particle composed of a particle core made of a soft magnetic metal and an insulating film formed at the surface of the particle core. JP 2022-060995 A also discloses that the particle core has an oxide film formed due to the oxidization of the soft magnetic metal. JP 2022-060995 A further discloses that the insulating film is an inorganic glass coating or a sol-gel reaction product. Note that, the sol-gel reaction product in JP 2022-060995 A contains a hydrocarbon group having a linear portion with 8 or more carbons.

In the soft magnetic particle described in JP 2022-060995 A, the insulating film is composed of an inorganic material such as glass or a sol-gel reaction product. The insulating film composed of an inorganic material has good insulating property but is highly hygroscopic. As such, the soft magnetic particle having the insulating film may unintentionally absorb moisture when in storage or when being transported. When the insulating film absorbs moisture, the insulating property between particles and the flowability of particles decrease. This results in a decrease in the insulation property or the green density of the magnetic powder core prepared using the soft magnetic particles.

The situation presents the challenge of realizing an insulator-coated soft magnetic powder that has excellent moisture resistance and in which a decrease in insulating property and flowability due to moisture absorption is suppressed.

### SUMMARY

An insulator-coated soft magnetic powder according to an application example of the present disclosure includes
a soft magnetic powder,
an inorganic insulating film including a ceramic and covering the particle surface of the soft magnetic powder, and
an organic film including a compound derived from a coupling agent having a hydrophobic functional group and covering the surface of the inorganic insulating film, wherein
the inorganic insulating film has an average thickness of from 5 nm to 100 nm, and
the insulator-coated soft magnetic powder has a water content of from 30 ppm to 400 ppm, as measured by the Karl Fischer method at 250° C. after the insulator-coated soft magnetic powder is left in an environment of atmospheric pressure, a temperature of 30° C., and a relative humidity of 80% for 24 hours.

A magnetic powder core according to an application example of the present disclosure includes the insulator-coated soft magnetic powder according to an application example of the present disclosure.

A magnetic element according to an application example of the present disclosure includes the magnetic powder core according to an application example of the present disclosure.

An electronic device according to an application example of the present disclosure includes the magnetic element according to an application example of the present disclosure.

### BRIEF DESCRIPTION OF THE DRAWINGS

FIG. 1 is a cross-sectional view schematically illustrating a particle of an insulator-coated soft magnetic powder according to an embodiment.

FIG. 2 is a process diagram for explaining a method for producing the insulator-coated soft magnetic powder.

FIG. 3 is a plan view schematically illustrating a toroidal coil component.

FIG. 4 is a transparent perspective view schematically illustrating a closed magnetic circuit coil component.

FIG. 5 is a perspective view illustrating a portable personal computer that is an electronic device including a magnetic element according to an embodiment.

FIG. 6 is a plan view illustrating a smart phone that is an electronic device including the magnetic element according to an embodiment.

FIG. 7 is a perspective view illustrating a digital still camera that is an electronic device including the magnetic element according to an embodiment.

### DESCRIPTION OF EMBODIMENTS

Hereinafter, an insulator-coated soft magnetic powder, a magnetic powder core, a magnetic element, and an electronic device according to an aspect of the present disclosure will be described in detail with reference to preferred embodiments illustrated in accompanying drawings.

### 1. Insulator-Coated Soft Magnetic Powder

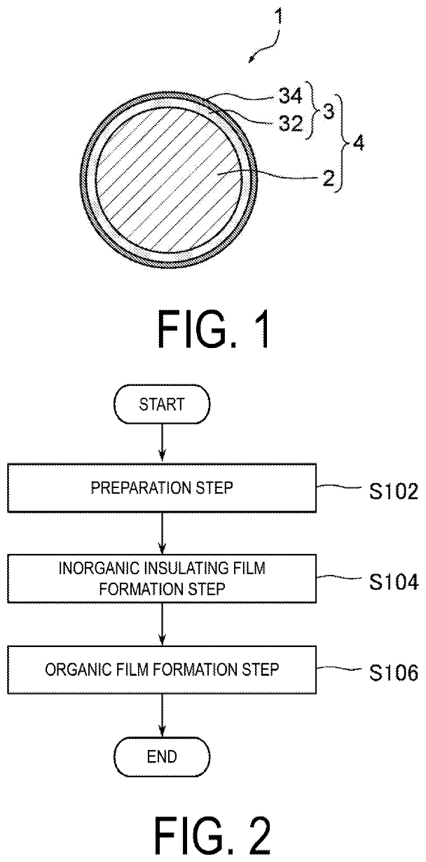

First, an insulator-coated soft magnetic powder according to an embodiment will be described. FIG. 1 is a cross-sectional view schematically illustrating a particle of an insulator-coated soft magnetic powder 1 according to an embodiment. Note that, in the following description, a particle of the insulator-coated soft magnetic powder 1 is also referred to as an “insulator-coated soft magnetic particle 4”.

The insulator-coated soft magnetic particle 4 illustrated in FIG. 1 includes a soft magnetic particle 2 and an insulating coating film 3 provided at the surface of the soft magnetic particle 2. Of which, the soft magnetic particle 2 contains a soft magnetic material which will be described later. The insulating coating film 3 covers the surface of the soft magnetic particle 2 and has insulating property. Note that, the term “covering” in the present specification is a concept that includes both a state of the entire surface of the soft magnetic particle 2 being covered and a state of a part of the surface of the soft magnetic particle 2 being covered. In the following description, soft magnetic particles 2 are also collectively referred to as “soft magnetic powder”.

As will be described later, the insulator-coated soft magnetic particle 4 has excellent moisture resistance, and a decrease in the insulating property and flowability of the insulator-coated soft magnetic particle 4 due to moisture absorption is suppressed. For this reason, in a green compact obtained by compacting the insulator-coated soft magnetic powder 1, even when moisture absorption occurs, the insulating property among the insulator-coated soft magnetic particles 4 is good and a high filling property can be achieved, which results in a high green density. As such, the resulting magnetic powder core has good withstand voltage and magnetic properties.

### 1.1. Soft Magnetic Particle

The soft magnetic particle 2 is composed of a soft magnetic material. Examples of the soft magnetic material include a material containing at least one of Fe, Ni, or Co as a main component, that is, a material containing one or more of these elements in an atomic ratio of 50% or greater. In addition to these elements serving as the main components, the soft magnetic material may also contain at least one element selected from the group consisting of Cr, Nb, Cu, Al, Mn, Mo, Si, Sn, B, C, P, Ti, and Zr, depending on the target property. The soft magnetic material may also contain unavoidable impurities as long as the effects of the present embodiment are not impaired. Unavoidable impurities are impurities that are unintentionally mixed along with the raw materials or during production. The unavoidable impurities include all elements other than the above-described elements, and examples thereof include O, N, S, Na, Mg, and K.

Specific examples of the soft magnetic material include Fe—Si alloys such as silicon steel, Fe—Si—Al alloys such as Sendust, as well as Fe alloys such as Fe—Ni alloys, Fe—Co alloys, Fe—Ni—Co alloys, Fe—Si—B alloys, Fe—Si—B—C alloys, Fe—Si—B—Cr—C alloys, Fe—Si—Cr alloys, Fe—B alloys, Fe—P—C alloys, Fe—Co—Si—B alloys, Fe—Si—B—Nb alloys, Fe—Si—B—Nb—Cu alloys, Fe—Zr—B alloys, Fe—Cr alloys, and Fe—Cr—Al alloys, Ni alloys such as Ni—Si—B alloys and Ni—P—B alloys, and Co alloys such as Co—Si—B alloys.

By using the soft magnetic material having such a composition, the resulting insulator-coated soft magnetic particle 4 can have high magnetic properties, such as permeability and magnetic flux density, as well as low coercivity.

The content of the above-described main component in the soft magnetic material is preferably 50% or greater, and more preferably 70% or greater in terms of atomic ratio. This makes it possible to particularly improve the magnetic properties of the insulator-coated soft magnetic particle 4, such as the permeability and the magnetic flux density.

The structure constituting the soft magnetic material is not limited, and may be any of a crystalline structure, an amorphous structure, and a microcrystalline (nanocrystalline) structure. Among them, the soft magnetic material preferably contains an amorphous or microcrystalline structure. By including the foregoing, the coercivity decreases, which contributes to a reduction in the hysteresis loss of magnetic element. Note that, in the soft magnetic material, structures of different crystallinities may be present at the same time.

Examples of an amorphous material and a microcrystalline material include Fe alloys such as Fe—Si—B alloys, Fe—Si—B—C alloys, Fe—Si—B—Cr—C alloys, Fe—Si—Cr alloys, Fe—B alloys, Fe—P—C alloys, Fe—Co—Si—B alloys, Fe—Si—B—Nb alloys, Fe—Si—B—Nb—Cu alloys, and Fe—Zr—B alloys, Ni alloys such as Ni—Si—B alloys and Ni—P—B alloys, and Co alloys such as Co—Si—B alloys.

The composition of the soft magnetic material is identified by the following analysis method.

Examples of the analysis method include Iron and Steel—Atomic Absorption Spectrometric Method specified in JIS G 1257:2000, Iron and Steel—ICP Emission Spectrometric Method specified in JIS G 1258:2007, Iron and Steel—Method for Spark Discharge Atomic Emission Spectrometric Analysis specified in JIS G 1253:2002, Iron and Steel—Method For X-Ray Fluorescence Spectrometric Analysis specified in JIS G 1256:1997, and Weight/Titration/Absorption Spectroscopy specified in JIS G 1211 to G 1237.

Specifically, solid-state emission spectrometers available from SPECTRO Analytical Instruments, in particular the spark discharge emission spectrometer LAVMB08A of the model SPECTROLAB, and an ICP device CIROS120 available from Rigaku Corporation may be used.

In particular, the oxygen stream combustion (high-frequency induction heating furnace combustion)-infrared absorption method specified in JIS G 1211:2011 is also used to identify carbon (C) and sulfur(S). Specifically, a carbon/sulfur analyzer CS-200 available from LECO Corporation may be used.

Further, in particular, the iron and steel-nitrogen quantification method specified in JIS G 1228:1997 and the general rule of oxygen quantification method for metallic materials specified in JIS Z 2613:2006 are used to identify nitrogen (N) and oxygen (O). Specifically, TC-300/EF-300, an oxygen/nitrogen analyzer available from LECO Corporation, may be used.

In the volume-based particle size distribution of the soft magnetic powder, when the particle size at a cumulative frequency of 50% is defined as the average particle size, the average particle size of the soft magnetic powder is preferably from 1 μm to 20 μm, more preferably from 2 μm to 15 μm, and even more preferably from 3 μm to 9 μm.

When the average particle size of the soft magnetic powder is within the above range, the path of intra-particle eddy currents of the soft magnetic particle 2 becomes short, making it possible to sufficiently reduce the eddy current loss of magnetic element in a high frequency region. In addition, when the average particle size of the soft magnetic powder is within the above range, the filling property at the time of compacting becomes high, making it possible to improve magnetic properties such as the permeability of the green compact and the saturation magnetic flux density.

Note that, when the average particle size of the soft magnetic powder is less than the lower limit value described above, aggregation is likely to occur, making it difficult to form the insulating coating film 3 and leading to a possible deterioration in the filling property at the time of compacting. Meanwhile, when the average particle size of the soft magnetic powder exceeds the upper limit value, the path of intra-particle eddy currents becomes long, leading to a possible increase in the eddy current loss due to intra-particle eddy currents.

The volume-based particle size distribution of the soft magnetic powder can be measured using, for example, a laser diffraction particle size distribution analyzer.

### 1.2. Insulating Coating Film

The insulating coating film 3 covers the surface of the soft magnetic particle 2. The insulating coating film 3 illustrated in FIG. 1 has a two-layer structure that includes an inorganic insulating film 32 and an organic film 34. The inorganic insulating film 32 covers the surface of the soft magnetic particle 2 and contains a ceramic. The organic film 34 covers the surface of the inorganic insulating film 32 and contains a compound derived from a coupling agent having a hydrophobic functional group.

### 1.2.1. Inorganic Insulating Film

The inorganic insulating film 32 contains a ceramic and covers the surface of the soft magnetic particle 2. Examples of the constituent component of the ceramic include oxide compounds and non-oxide compounds.

Examples of the oxide compound include a silicon oxide such as SiO₂, a magnesium oxide such as MgO, a calcium oxide such as Cao, an aluminum oxide such as Al₂O₃, a titanium oxide such as TiO₂, a zirconium oxide such as ZrO₂, a boron oxide such as B₂O₃, an yttrium oxide such as Y₂O₃, a phosphorus oxide such as P₂O₅, a bismuth oxide such as Bi₂O₃, a zinc oxide such as ZnO, a tin oxide such as Sno, a lead oxide such as PbO, a lithium oxide such as Li₂O, a sodium oxide such as Na₂O, a potassium oxide such as K₂O, a strontium oxide such as SrO, a barium oxide such as BaO, a gadolinium oxide such as Gd₂O₃, a lanthanum oxide such as La₂O₃, and a ytterbium oxide such as Yb₂O₃. Note that these composition formulas are examples of the composition ratio of each compound, and each compound may have a composition ratio other than the above-mentioned composition ratio.

Examples of the non-oxide compound include silicon nitride such as Si₃N₄, aluminum nitride such as AlN, boron nitride such as BN, titanium nitride such as TiN, and tungsten nitride such as WN.

The ceramic in the present specification is composed of one of these constituent components or a mixture of two or more of these constituent components. In addition, the ceramic in the present specification may be crystalline, amorphous (vitreous), or a mix of crystalline and amorphous (vitreous).

Among them, the ceramic preferably contains a silicon oxide or an aluminum oxide. A silicon oxide or an aluminum oxide have particularly good insulating property and chemical stability, and they are also readily available. As such, by using the ceramic containing these constituent components, the resulting inorganic insulating film 32 has good insulating property over a long period of time.

The inorganic insulating film 32 may contain a component in addition to the constituent components described above. The content of the above constituent components in the inorganic insulating film 32 is preferably 50 mass % or greater, more preferably 70 mass % or greater, and even more preferably 90 mass % or greater. This gives the inorganic insulating film 32 particularly good insulating property.

The average thickness of the inorganic insulating film 32 is from 5 nm to 100 nm, preferably from 10 nm to 70 nm, and more preferably from 15 nm to 50 nm. When the average thickness of the inorganic insulating film 32 is within the above range, the occupancy of the inorganic insulating film 32 in the magnetic powder core can be reduced to increase the filling rate of the soft magnetic powder, and the insulating property of the inorganic insulating film 32 can be sufficiently ensured at the same time. In addition, when the surface of the soft magnetic particle 2 has unevenness, the inorganic insulating film 32 also contributes by evening out and smoothing the unevenness, bringing the surface of the soft magnetic particle 2 closer to a spherical shape. This allows for the organic film 34 to be formed with a more uniform thickness, which can further increase the flowability of the insulator-coated soft magnetic powder 1.

When the average thickness of the inorganic insulating film 32 is less than the lower limit value, the insulating property of the inorganic insulating film 32 becomes insufficient, and the unevenness at the surface of the soft magnetic particle 2 cannot be sufficiently smoothed. Meanwhile, when the average thickness of the inorganic insulating film 32 exceeds the upper limit value, the inorganic insulating film 32 tends to peel off, or the filling rate of the soft magnetic powder in the magnetic powder core may decrease.

Note that, the average thickness of the inorganic insulating film 32 is measured by, for example, magnifying and observing a cross section of the insulator-coated soft magnetic particle 4. Specifically, a focused ion beam is used to cut the insulator-coated soft magnetic particle 4 and prepare a cross-sectional slice sample. Next, the prepared cross-sectional slice sample is observed using a scanning transmission electron microscope, and the thickness of the inorganic insulating film 32 is measured at five or more spots in one insulator-coated soft magnetic particle 4. Then, the measured values are averaged, and the result calculated is taken as the average thickness of the inorganic insulating film 32. The distribution range of the inorganic insulating film 32 in the image observed can be more clearly confirmed by using EDX analysis (energy dispersive X-ray analysis), Auger electron spectroscopy, or the like in combination.

The inorganic insulating film 32 may contain ceramic particles composed of the ceramic described above. By making the ceramic particles smaller than the soft magnetic particle 2, the ceramic particles can be distributed covering the surface of the soft magnetic particle 2. This allows for a dense inorganic insulating film 32 having a sufficient film thickness to be easily obtained. Such inorganic insulating film 32 has particularly high insulating property.

The average particle size of the ceramic particles is not limited, but is preferably from 1 nm to 50 nm, more preferably from 3 nm to 30 nm, and even more preferably from 5 nm to 10 nm. This makes it easy for the ceramic particles to distribute uniformly at the surface of the soft magnetic particle 2. As a result, the thickness of the inorganic insulating film 32 becomes more uniform, and the insulating property can be improved.

Note that, the particle size of the ceramic particles is an equivalent circle diameter determined from the image of the above-described cross-sectional slice sample observed under a scanning transmission electron microscope. Then, the average value of the equivalent circle diameters obtained from five or more ceramic particles is defined as the average particle size of the ceramic particles.

### 1.2.2. Organic Film

The organic film 34 is formed by a reaction of a coupling agent having a hydrophobic functional group at the surface of the inorganic insulating film 32. Therefore, the organic film 34 contains a compound derived from the coupling agent having a hydrophobic functional group and exhibits properties derived from the hydrophobic functional group.

Examples of the hydrophobic functional group include a saturated hydrocarbon group, a cyclic structure-containing group, a fluoroalkyl group, a fluoroaryl group, a nitro group, an acyl group, and a cyano group. These groups impart good moisture resistance to the organic film 34.

Among these groups, the hydrophobic functional group is preferably a saturated hydrocarbon group, and more preferably a linear alkyl group having from 1 to 6 carbons. This imparts particularly high moisture resistance to the organic film 34. Note that, when the number of carbons exceeds the upper limit value, it is difficult to achieve a state in which adjacent long-chain alkyl groups are arranged regularly. That is, the arrangement of adjacent long-chain alkyl groups may be disrupted. This may lead to a decrease in the moisture resistance of the organic film 34.

The hydrophobic functional group is preferably a cyclic structure-containing group, a fluoroalkyl group, or a fluoroaryl group. These groups impart particularly high moisture resistance to the organic film 34. In addition, the cyclic structure-containing group having a cyclic structure and the fluoroaryl group have high stability, and thus good moisture resistance can be maintained even after heating. In addition, in a fluoroalkyl group having a fluorine atom or a fluoroaryl group having a fluorine atom, surface tension resulting from the fluorine atom is low, and thus hydrophobicity excellent. As a result, good moisture resistance can be achieved even after heating. Therefore, the insulator-coated soft magnetic powder 1 with excellent flowability and good filling property during compacting can be obtained even in a humid environment.

The cyclic structure-containing group is a functional group having a cyclic structure. Examples of the cyclic structure-containing group include an aromatic hydrocarbon group, an alicyclic hydrocarbon group, and a cyclic ether group.

The aromatic hydrocarbon group is a residue obtained by removing a hydrogen atom from aromatic hydrocarbon, and preferably has from 6 to 20 carbons. Examples of the aromatic hydrocarbon group include an aryl group, an alkylaryl group, an aminoaryl group, and a halogenated aryl group. Examples of the aryl group include a phenyl group, a tolyl group, a xylyl group, a naphthyl group, and an indenyl group. Examples of the alkylaryl group include a benzyl group, a methylbenzyl group, a phenethyl group, a methylphenethyl group, and a phenylbenzyl group. Note that the aromatic hydrocarbon group may be substituted with a substituent such as an alkyl group having from 1 to 3 carbons.

The alicyclic hydrocarbon group is a residue obtained by removing a hydrogen atom from alicyclic hydrocarbon, and preferably has from 3 to 20 carbons. Examples of the alicyclic hydrocarbon group include a cycloalkyl group and a cycloalkylalkyl group. Examples of the cycloalkyl group include a cyclopropyl group, a cyclobutyl group, a cyclopentyl group, and a cyclohexyl group. Examples of the cycloalkylalkyl group include a cyclopentylmethyl group and a cyclohexylmethyl group. The alicyclic hydrocarbon group may be substituted with a substituent such as an alkyl group having from 1 to 3 carbons.

Examples of the cyclic ether group include an epoxy group, a 3,4-epoxycyclohexyl group, and an oxetanyl group. The cyclic ether group may be substituted with a substituent such as an alkyl group having from 1 to 3 carbons.

The fluoroalkyl group is an alkyl group having from 1 to 16 carbons with substitution of one or more fluorine atoms or a cycloalkyl group having from 3 to 16 carbons with substitution of one or more fluorine atoms. In particular, the fluoroalkyl group is preferably a perfluoroalkyl group.

The fluoroaryl group is an aryl group having from 6 to 20 carbons with substitution of one or more fluorine atoms. In particular, the fluoroaryl group is preferably a perfluoroaryl group.

The average thickness of the organic film 34 is preferably smaller than the average thickness of the inorganic insulating film 32. This makes the organic film 34 a monomolecular film or a molecular film close to a monomolecular film, sufficiently reducing the occupancy of the organic film 34 in the insulator-coated soft magnetic powder 1 while ensuring the moisture resistance derived from the hydrophobic functional group. As such, the resulting magnetic powder core has high magnetic properties.

The average thickness of the organic film 34 is preferably 1% or greater and less than 100%, more preferably from 3% to 50%, and even more preferably from 5% to 20% of the average thickness of the inorganic insulating film 32. This can ensure the film thickness necessary for maintaining the organic film 34 while further reducing the occupancy of the organic film 34 in the insulator-coated soft magnetic powder 1.

The average thickness of the organic film 34 can be specified by, for example, qualitative and quantitative analysis in a depth direction using X-ray photoelectron spectroscopy and ion sputtering in combination. Specifically, the concentration of components derived from the coupling agent is examined along a depth direction. The region having a high concentration of components derived from the coupling agent is taken as the average thickness of the organic film 34. Specifically, when the concentration changes in the vicinity of the boundary between the organic film 34 and the inorganic insulating film 32, the position corresponding to half the amount of change in concentration, that is, the midpoint between the concentration on the organic film 34 side and the concentration on the inorganic insulating film 32 side, is regarded as the boundary, and the thickness on the surface side of the boundary may be taken as the average thickness of the organic film 34.

The insulating coating film 3 having the two-layer structure as described above yields the following effects.

First, the inorganic insulating film 32 has good insulating property derived from the ceramic. For this reason, the insulator-coated soft magnetic particles 4 are well insulated from each other even if the inorganic insulating film 32 is thin. As a result, by compacting the insulator-coated soft magnetic powder 1, eddy currents between particles are suppressed, and the resulting magnetic powder core has good withstand voltage. In addition, the inorganic insulating film 32 can smooth the unevenness on the surface of the soft magnetic particle 2 and bring the surface of the soft magnetic particle 2 closer to a spherical shape. As a result, the flowability of the insulator-coated soft magnetic powder 1 increases, allowing the magnetic powder core produced to have a high filling rate. Furthermore, the inorganic insulating film 32 has a relatively high concentration of hydroxyl groups derived from the ceramic. Therefore, the inorganic insulating film 32 can bond with the coupling agent at a high density, which contributes to an increase in the density of the hydrophobic functional group.

Meanwhile, the organic film 34 covers the inorganic insulating film 32, thereby imparting hydrophobicity to the surface. This can increase the moisture resistance of the insulator-coated soft magnetic powder 1. As a result, the insulator-coated soft magnetic powder 1 that is less likely to have a decrease in flowability can be obtained despite being placed in a high-humidity environment. In addition, by providing the inorganic insulating film 32 as a base, the density of the hydrophobic functional group can be increased, and the bonding strength of the compound derived from the coupling agent can also be increased. This can sufficiently increase the moisture resistance of the organic film 34, and the resulting insulator-coated soft magnetic powder 1 is less likely to have a decrease in the flowability even when the particles rub against each other. In addition, adhesion between the insulator-coated soft magnetic powder 1 and the binder is improved during the production of the magnetic powder core. As such, the resulting magnetic powder core has high mechanical strength.

### 1.3. Water Content

The water content of the insulator-coated soft magnetic powder 1 is preferably from 30 ppm to 400 ppm, more preferably from 40 ppm to 300 ppm, and even more preferably from 50 ppm to 200 ppm in terms of mass ratio. When the water content of the insulator-coated soft magnetic powder 1 is within the above range, the insulator-coated soft magnetic powder 1 is less likely to absorb moisture and less likely to have a decrease in flowability. In addition, rusting of the soft magnetic particle 2 due to moisture can be suppressed, and thus deterioration of magnetic properties in the magnetic powder core can also be suppressed.

Note that when the water content is below the lower limit value, the hydrophobicity may become excessive and the filling property during compacting may decrease. Meanwhile, when the water content exceeds the upper limit value, the flowability of the insulator-coated soft magnetic powder 1 may decrease and the soft magnetic particle 2 may rust because the water content is too much.

The water content of the insulator-coated soft magnetic powder 1 is measured as follows.

First, the insulator-coated soft magnetic powder 1 is left in an environment of atmospheric pressure, a temperature of 30° C., and a relative humidity of 80% for 24 hours. Next, the insulator-coated soft magnetic powder 1 is heated to 250° C., and the water content in that state is measured by the Karl Fischer method. When measuring water content using the Karl Fischer method, a water content measuring device CA-310 available from Nittoseiko Analytech Co., Ltd. can be used, for example.

### 2. Method of Producing Insulator-Coated Soft Magnetic Powder

Next, a method for producing the insulator-coated soft magnetic powder 1 will be described.

FIG. 2 is a process diagram for explaining a method for producing the insulator-coated soft magnetic powder 1.

The method of producing the insulator-coated soft magnetic powder illustrated in FIG. 2 includes a preparation step S102, an inorganic insulating film formation step S104, and an organic film formation step S106.

### 2.1. Preparation Step

In the preparation step S102, the soft magnetic powder is prepared. The soft magnetic powder may be a powder produced by any method. Examples of the production method include various atomization methods such as water atomization, gas atomization, and rotary water jet atomization, as well as a reduction method, a carbonyl method, and a pulverization method. Among these examples, an atomization method is preferable. That is, the soft magnetic powder is preferably an atomized powder. An atomized powder is fine, has high sphericity, and high production efficiency. Further, in particular, water atomized powder or rotary water jet atomized powder has a thin oxide film on the surface of the powder because it is produced by the contact between a molten metal and water. This oxide film can serve as a base of the insulating coating film 3. Therefore, the adhesion between the soft magnetic particle 2 and the insulating coating film 3 is excellent, and the insulator-coated soft magnetic particles 4 eventually produced have particularly high insulation between the particles. In addition, the fast cooling speed allows for the soft magnetic powder produced to contain an amorphous structure or a microcrystalline structure.

### 2.2. Inorganic Insulating Film Formation Step

In the inorganic insulating film formation step S104, the inorganic insulating film 32 covering the surface of the soft magnetic particle 2 is formed.

The method for forming the inorganic insulating film 32 is not limited, and examples thereof include dry formation methods such as the mechanochemical method, plasma polymerization, atomic layer deposition (ALD), chemical vapor deposition (CVD), and ion plating, as well as wet formation methods such as the sol-gel method and the electrolytic reduction method.

Hereinafter, the mechanochemical method and the sol-gel method will be sequentially described as representative methods.

### 2.2.1. Mechanochemical Method

The mechanochemical method is a method of applying mechanical stress to ceramic particles to change the physicochemical properties of the ceramic particles. For example, when a mechanical interaction (mechanochemical reaction) is caused between the soft magnetic particle 2 and the ceramic particles by using a mechanochemical reaction device having a cylindrical chamber that is equipped with a compression tool and a blade and that rotates at high speed, the inorganic insulating film 32 can be formed at the surface of the soft magnetic particle 2. By using such a mechanical coating formation method, the inorganic insulating film 32 can adhere well to the surface of the soft magnetic particle 2 even when contaminants are attached to the surface of the soft magnetic particle 2, or when the adhesion force is small, or when the surface roughness is small. In addition, since the inorganic insulating film 32 is not exposed to high temperatures during the formation process, the thermal degradation of the soft magnetic particle 2, such as unintended crystal coarsening, can be suppressed. As such, a deterioration in the soft magnetism of the soft magnetic particle 2 can be suppressed.

Note that, examples of the mechanochemical reaction device include the pulverizers “Nobilta” (trade name) and “Mechanofusion” (trade name) available from Hosokawa Micron Corporation, and the pulverizer “Hybridizer” (trade name) available from Nara Machinery Co., Ltd.

### 2.2.3. Sol-Gel Method

The sol-gel method is a method for preparing ceramics by hydrolyzing a metal alkoxide. For example, when using a silicon oxide to form a film that serve as the inorganic insulating film 32, a hydrolysis reaction of a silicon alkoxide can be utilized. Hereinafter, a method using a silicon alkoxide will be described.

First, the soft magnetic particles 2 are dispersed in an alcohol solution containing a silicon alkoxide. Examples of the alcohol solution include solutions of lower alcohols such as ethanol and methanol. For example, from 10 parts by mass to 50 parts by mass of alcohol may be mixed with 1 part by mass of tetraethoxysilane.

Next, aqueous ammonia is mixed as a catalyst that promotes the reaction, causing hydrolysis. As a result, a dehydration condensation reaction occurs between the hydrolysates or between the hydrolysate and the silicon alkoxide, forming —Si—O—Si— bonds at the particle surface. This results in the inorganic insulating film 32 composed of a silicon oxide.

### 2.3. Organic Film Formation Step

In the organic film formation step S106, a coupling agent having a hydrophobic functional group is reacted with the soft magnetic particles 2. This causes the coupling agent to attach to the surface of the inorganic insulating film 32.

For this operation, the following three operations are the examples.

The first operation include putting both the soft magnetic particles 2 on which the inorganic insulating film 32 is formed and the coupling agent into a chamber and then heating the inside of the chamber.

The second operation include putting the soft magnetic particles 2 on which the inorganic insulating film 32 is formed into a chamber, and then spraying the coupling agent into the chamber while stirring the soft magnetic particles 2.

The third operation include putting water, a coupling agent, an alkaline solution such as ammonia or sodium hydroxide, and the soft magnetic particles 2 on which the inorganic insulating film 32 is formed into a primary alcohol such as methanol, ethanol, or isopropyl alcohol, and then performing stirring, filtering, and drying.

Examples of the coupling agent include a silane coupling agent, a titanium coupling agent, and a zirconium coupling agent.

The following chemical formula is an example of a molecular structure of the silane coupling agent.

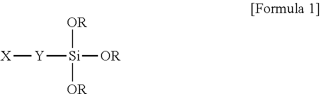

where X is a functional group, Y is a spacer, and OR is a hydrolyzable group. Note that, R is a methyl group or an ethyl group, for example.

Examples of the spacer include an alkylene group, an arylene group, an aralkylene group, and an alkylene ether group.

The hydrolyzable group is, for example, an alkoxy group, a halogen atom, a cyano group, an acetoxy group, or an isocyanate group; among these, in the case of an alkoxy group, hydrolysis yields silanol. The silanol reacts with a hydroxyl group generated at the surface of the inorganic insulating film 32, and the coupling agent adheres to the surface of the inorganic insulating film 32.

At least one such hydrolyzable group may be contained in the coupling agent, but preferably two or more of such hydrolyzable groups are contained, and more preferably three such hydrolyzable groups are contained as illustrated by the above formula. For example, the coupling agent in which the hydrolyzable group is an alkoxy group preferably contains a dialkoxy group, and more preferably contains a trialkoxy group. The coupling agent containing a trialkoxy group reacts with three hydroxyl groups generated at the surface of the inorganic insulating film 32. This results in good adhesion to the inorganic insulating film 32. In addition, the coupling agent containing a trialkoxy group has excellent film-formation property, and thus the resulting organic film 34 has excellent continuity. Such organic film 34 contributes to a further increase in the flowability of the insulator-coated soft magnetic powder 1.

In addition, in the coupling agent containing a trialkoxy group, even when the hydrophobic functional group is thermally decomposed after the organic film 34 is formed, the remaining part can continue to cover the surface of the inorganic insulating film 32. As such, a decrease in hydrophobicity can be suppressed.

Here, examples of the coupling agent having a hydrophobic functional group are presented. Examples of the coupling agent having an aromatic hydrocarbon group include:
phenyltrimethoxysilane represented by Formula (A-1) below:

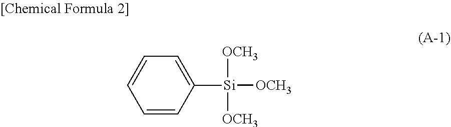 [SMILES: CO[Si](OC)(OC)c1ccccc1]

phenyltriethoxysilane represented by Formula (A-2) below:

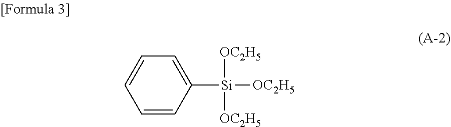 [SMILES: CCO[Si](OCC)(OCC)c1ccccc1]

dimethoxydiphenylsilane represented by Formula (A-3) below:

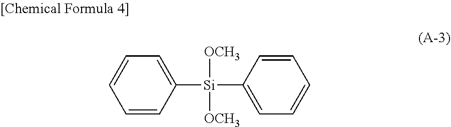 [SMILES: CO[Si](OC)(c1ccccc1)c1ccccc1]

2,2-dimethoxy-1-phenyl-1-aza-2-silacyclopentane represented by Formula (A-4) below:

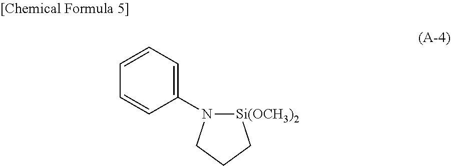

3-phenoxypropyltrichlorosilane represented by Formula (A-11) below:

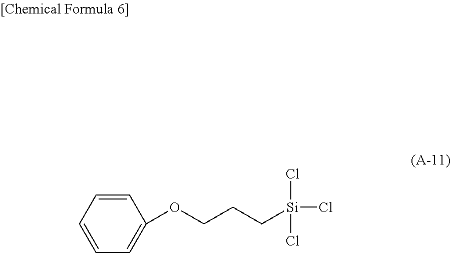 [SMILES: Cl[Si](Cl)(Cl)CCCOc1ccccc1]

phenyltriacetoxysilane represented by Formula (A-12) below:

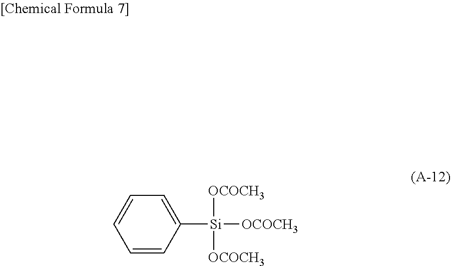

triethoxy (p-tolyl) silane represented by Formula (A-13) below:

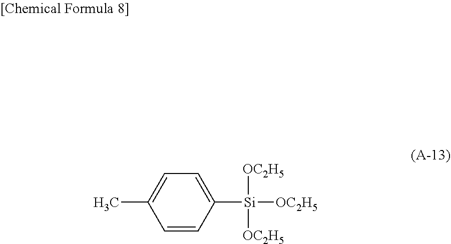 [SMILES: CCO[Si](OCC)(OCC)c1ccc(C)cc1]

p-aminophenyltrimethoxysilane represented by Formula (A-14) below:

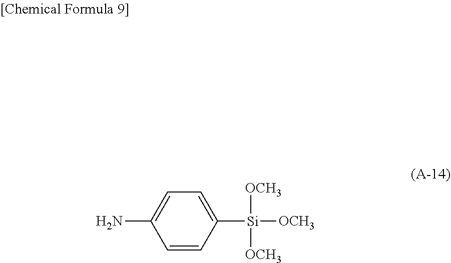 [SMILES: CO[Si](OC)(OC)c1ccc(N)cc1]

m-aminophenyltrimethoxysilane represented by Formula (A-15) below:

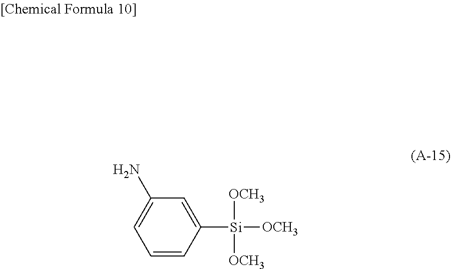 [SMILES: CO[Si](OC)(OC)c1cccc(N)c1]

((chloromethyl)phenylethyl)trimethoxysilane represented by Formula (A-16) below:

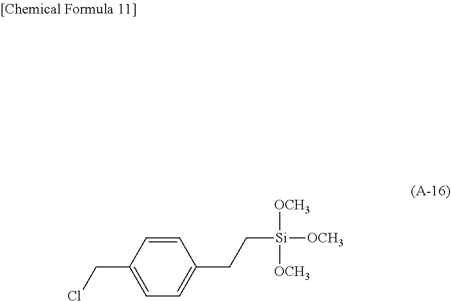 [SMILES: CO[Si](CCc1ccc(CCl)cc1)(OC)OC]

and the like.

Examples of the coupling agent having a cyclic ether group include:
3-glycidoxypropylmethyldimethoxysilane represented by Formula (A-5) below:

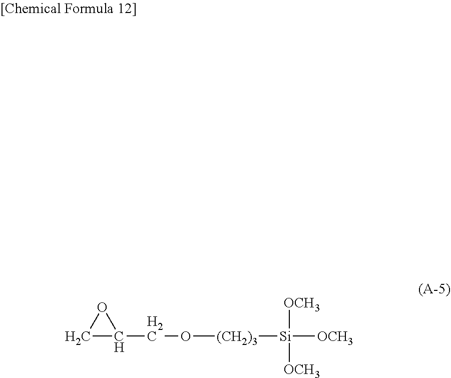

3-glycidoxypropyltrimethoxysilane represented by Formula (A-6) below:

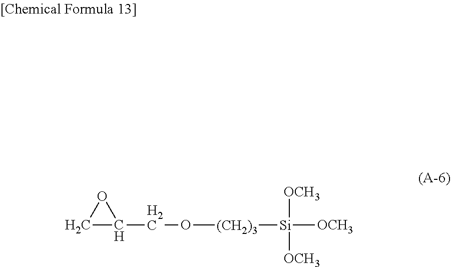

3-glycidoxypropylmethyldiethoxysilane represented by Formula (A-7) below:

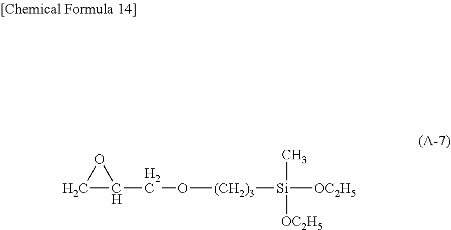

3-glycidoxypropyltriethoxysilane represented by Formula (A-8) below:

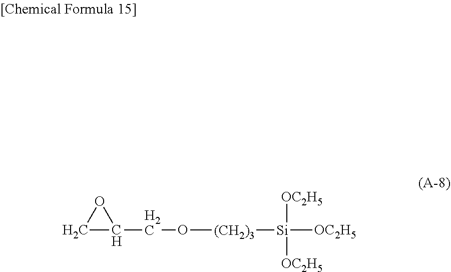

and the like.

Examples of the coupling agent having a fluoroalkyl group include:
trimethoxy (3, 3,3-trifluoropropyl) silane represented by Formula (B-1) below:

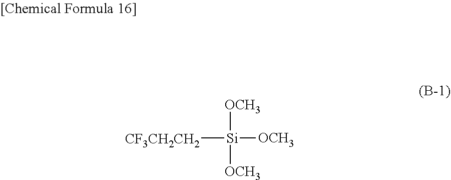

trimethoxy (1H, 1H, 2H, 2H-tridecafluoro-n-octyl) silane represented by Formula (B-2) below:

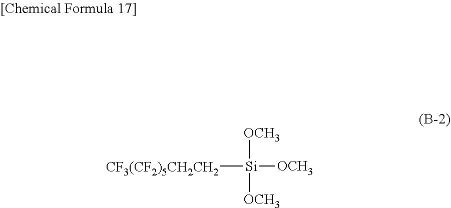

trimethoxy (1H, 1H, 2H, 2H-nonafluorohexyl) silane represented by Formula (B-3) below:

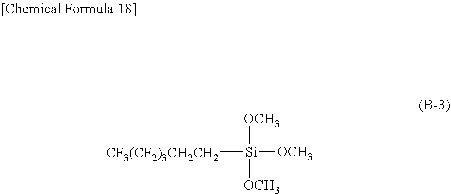

and the like.

Examples of the coupling agent having a fluoroaryl group include:
trimethoxy (11-pentafluorophenoxyundecyl) silane represented by Formula (C-1) below:

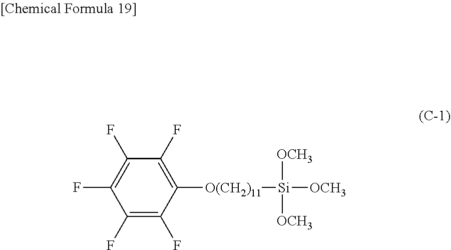

pentafluorophenyldimethylchlorosilane represented by Formula (C-2) below:

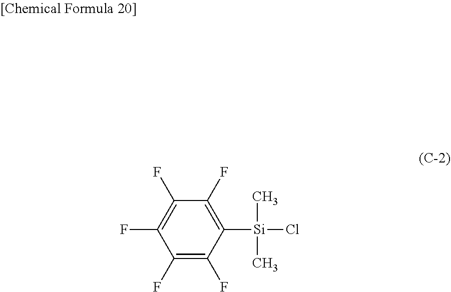

and the like.

The amount of the coupling agent to be added is not limited, but is preferably from 0.01 mass % to 1.00 mass %, and more preferably from 0.05 mass % to 0.50 mass %, with respect to the soft magnetic particles 2.

Further, the coupling agent is supplied into the chamber by a method such as leaving the coupling agent in the chamber or spraying the coupling agent into the chamber.

Thereafter, the soft magnetic particles 2 to which the coupling agent is attached are heated. Thereby, the organic film 34 is formed at the surface of the inorganic insulating film 32, resulting in the insulator-coated soft magnetic powder 1. Moreover, unreacted coupling agent can be removed by heating.

The heating temperature of the soft magnetic particles 2 to which the coupling agent is attached is not limited, but is preferably from 50° C. to 300° C., more preferably from 100° C. to 250° C. The heating time is preferably from 10 minutes to 24 hours, more preferably from 30 minutes to 10 hours. Examples of the atmosphere of the heat treatment include an air atmosphere and an inert gas atmosphere.

### 3. Magnetic Powder Core and Magnetic Element

Next, the magnetic powder core and the magnetic element according to the embodiment will be described.

The magnetic element according to the embodiment can be applied to various magnetic elements having a magnetic core, such as a choke coil, an inductor, a noise filter, a reactor, a transformer, a motor, an actuator, a solenoid valve, and a generator. The magnetic powder core according to the embodiment can be applied to the magnetic core of these magnetic elements.

Hereinafter, two types of coil components will be described as representative examples of the magnetic element.

### 3.1. Toroidal Coil

First, a toroidal coil component which is an example of the magnetic element according to the embodiment will be described.

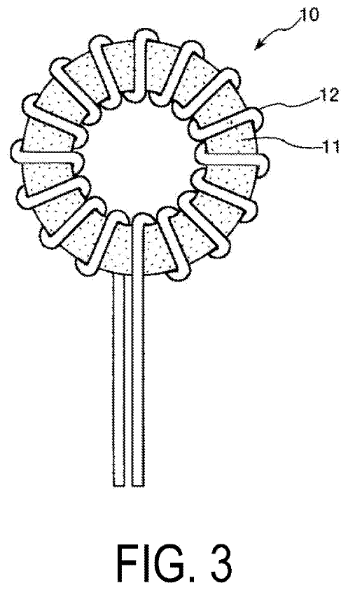

FIG. 3 is a plan view schematically illustrating a toroidal coil component.

A coil component 10 illustrated in FIG. 3 includes a ring-shaped magnetic powder core 11 and a conductive wire 12 wound around the magnetic powder core 11. Such a coil component 10 is generally referred to as a toroidal coil.

The magnetic powder core 11 is obtained by mixing the insulator-coated soft magnetic powder according to the embodiment with a binder, supplying the resulting mixture to a molding die, and performing pressing and molding. The magnetic powder core 11 is a green compact including the insulator-coated soft magnetic powder according to the embodiment, and thus the resulting coil component 10 has high permeability and high withstand voltage. Therefore, an electronic device or the like including the coil component 10 can have a high performance and a small size.

Examples of the constituent material of the binder used to prepare the magnetic powder core 11 include organic materials such as silicone-based resin, epoxy-based resin, phenol-based resin, polyamide-based resin, polyimide-based resin, and polyphenylene sulfide-based resin, as well as inorganic materials such as phosphates such as magnesium phosphate, calcium phosphate, zinc phosphate, manganese phosphate, and cadmium phosphate, and silicates such as sodium silicate. Of these, thermosetting polyimide or epoxy-based resins are particularly preferable. These resin materials are easily cured by heating, and are excellent in heat resistance. Therefore, the ease of producing the magnetic powder core 11 and the heat resistance of the magnetic powder core 11 can be increased.

The ratio of the binder to the insulator-coated soft magnetic powder varies slightly depending on the target magnetic properties and mechanical properties of the magnetic powder core 11 to be prepared, the allowable eddy current loss, and the like. The ratio is preferably approximately from 0.3 mass % to 5.0 mass %, more preferably approximately from 0.5 mass % to 3.0 mass %, and even more preferably approximately from 0.7 mass % to 2.0 mass %. This allows the particles of the soft magnetic powder to sufficiently bind to each other, and thus the resulting coil component 10 has excellent magnetic properties.

Various additives may be added to the mixture as necessary for any purpose.

Examples of the constituent material of the conductive wire 12 include highly conductive materials such as metal materials including Cu, Al, Ag, Au, and Ni. An insulating film may be provided at the surface of the conductive wire 12 as necessary.

The shape of the magnetic powder core 11 is not limited to the ring shape illustrated in FIG. 3, and may be, for example, a partially notched ring shape, a shape in which the shape in the longitudinal direction is linear, a sheet shape, or a film shape.

The magnetic powder core 11 may contain a soft magnetic powder other than the insulator-coated soft magnetic powder according to the above-described embodiment and/or a non-magnetic powder as necessary.

### 3.2. Closed Magnetic Circuit Coil

Next, a closed magnetic circuit coil component which is an example of the magnetic element according to the embodiment will be described.

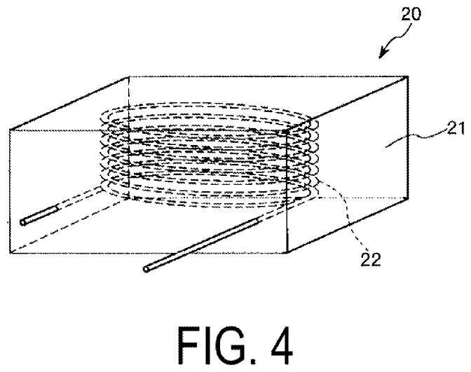

FIG. 4 is a transparent perspective view schematically illustrating a closed magnetic circuit coil component.

The following description of the closed magnetic circuit coil component mainly focuses on differences from the toroidal coil component, and descriptions on similar matters will be omitted.

As illustrated in FIG. 4, a coil component 20 according to the present embodiment is formed by embedding a conductive wire 22 formed in a coil shape inside a magnetic powder core 21. That is, the coil component 20, which is the magnetic element, includes a powder magnetic core 21 containing the above-mentioned insulator-coated soft magnetic powder, and a conductive wire 22 is molded with the powder magnetic core 21. The magnetic powder core 21 has the same configuration as the magnetic powder core 11 described above. As such, the resulting coil component 20 has excellent permeability and high withstand voltage.

Downsizing of the coil component 20 having such a configuration is relatively easy. Therefore, an electronic device or the like including the coil component 20 can have a high performance and a small size.

With the conductive wire 22 embedded in the magnetic powder core 21, a gap is less likely to be formed between the conductive wire 22 and the magnetic powder core 21. Therefore, vibration caused by magnetostriction of the magnetic powder core 21 can be suppressed, and noise generated due to the vibration can also be suppressed.

Note that, the shape of the magnetic powder core 21 is not limited to the shape illustrated in FIG. 4, and may be a sheet shape, a film shape, or the like.

The magnetic powder core 21 may contain a soft magnetic powder other than the insulator-coated soft magnetic powder according to the above-described embodiment and/or a non-magnetic powder as necessary.

### 4. Electronic Device

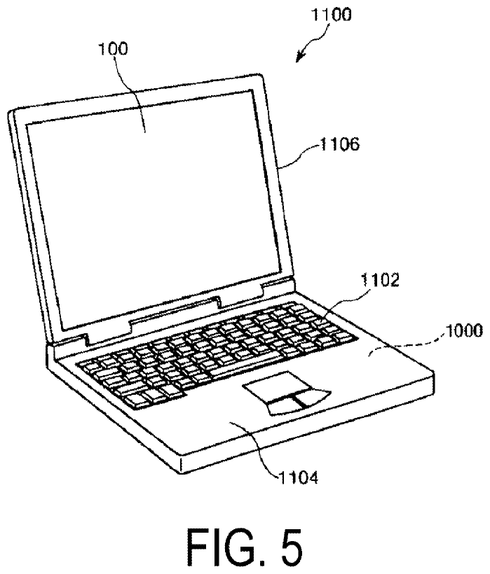

Next, an electronic device including the magnetic element according to the embodiment will be described with reference to FIG. 5 to FIG. 7.

FIG. 5 is a perspective view illustrating a portable personal computer that is an electronic device including the magnetic element according to the embodiment. A personal computer 1100 illustrated in FIG. 5 includes a main body 1104 provided with a keyboard 1102 and a display unit 1106 provided with a display unit 100. The display unit 1106 is rotatably supported via a hinge structure with respect to the main body 1104. A magnetic element 1000 such as a choke coil, an inductor, or a motor for a switching power supply is incorporated in the personal computer 1100.

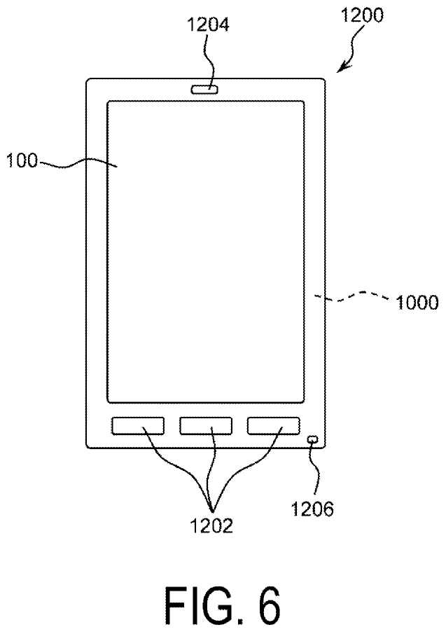

FIG. 6 is a plan view illustrating a smart phone that is an electronic device including the magnetic element according to the embodiment. A smart phone 1200 illustrated in FIG. 6 includes a plurality of operation buttons 1202, an earpiece 1204, and a mouthpiece 1206. The display unit 100 is disposed between the operation buttons 1202 and the earpiece 1204. The magnetic element 1000 such as an inductor, a noise filter, or a motor is incorporated in the smart phone 1200.

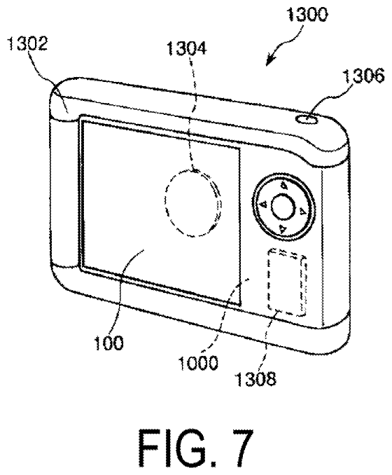

FIG. 7 is a perspective view illustrating a digital still camera that is an electronic device including the magnetic element according to the embodiment. A digital still camera 1300 generates a captured image signal by photoelectrically converting an optical image of a subject using an imaging element such as a charge coupled device (CCD).

The digital still camera 1300 illustrated in FIG. 7 includes the display unit 100 provided at the back surface of a case 1302. The display unit 100 functions as a viewfinder that displays the electronic image of the subject. A light receiving unit 1304 including an optical lens, a CCD, and the like is provided at the front side of the case 1302, that is, on the back side in the drawing.

When the photographer confirms the subject image displayed on the display unit 100 and presses a shutter button 1306, the captured image signal of the CCD at that time is transferred to and stored in a memory 1308. The digital still camera 1300 also incorporates the magnetic element 1000 such as an inductor or a noise filter.

In addition to the personal computer illustrated in FIG. 5, the smart phone illustrated in FIG. 6, and the digital still camera illustrated in FIG. 7, examples of the electronic device according to the embodiment include a mobile phone, a tablet terminal, a timepiece, an ink jet-type ejecting device such as an ink-jet printer, a laptop-type personal computer, a television, a video camera, a video tape recorder, a car navigation device, a pager, an electronic notebook, an electronic dictionary, a calculator, an electronic gaming device, a word processor, a workstation, a videophone, a security monitor, digital binoculars, a POS terminal, a digital thermometer, a blood pressure monitor, a blood glucose meter, an electrocardiogram measuring device, an ultrasonic diagnostic device, a medical device such as an electronic endoscope, a fish finder, various measuring devices, instruments for a vehicle, an aircraft, and a ship, a mobile control devices such as an automobile control device, an aircraft control device, a railroad vehicle control device, and a ship control device, as well as a flight simulator.

As described above, such an electronic device includes the magnetic element according to the embodiment. Accordingly, the effects of the magnetic element according to the embodiment, namely high permeability and high withstand voltage, can be enjoyed, and high performance and downsizing of the electronic device can be achieved.

### 5. Effects Achieved by Embodiment Described Above

As described above, the insulator-coated soft magnetic powder 1 according to the present embodiment includes the soft magnetic powder, the inorganic insulating film 32, and the organic film 34. The inorganic insulating film 32 covers the particle surface of the soft magnetic powder (the surfaces of the soft magnetic particles 2) and contains a ceramic. The organic film 34 covers the surface of the inorganic insulating film 32 and contains a compound derived from a coupling agent having a hydrophobic functional group. In the insulator-coated soft magnetic powder 1, the average thickness of the inorganic insulating film 32 is from 5 nm to 100 nm. The insulator-coated soft magnetic powder 1 has a water content of from 30 ppm to 400 ppm when measured at 250° C. by the Karl Fischer method after being left in an environment of atmospheric pressure, a temperature of 30° C., and a relative humidity of 80% for 24 hours.

With a configuration, the resulting insulator-coated soft magnetic powder 1 has excellent moisture resistance, and a decrease in the insulating property and flowability of the insulator-coated soft magnetic powder 1 due to moisture absorption is suppressed. As a result, eddy currents between particles are suppressed, and the resulting magnetic powder core has good withstand voltage. In addition, the filling rate of the magnetic powder core can be increased, and the resulting magnetic powder core has high permeability and high mechanical strength. Furthermore, the adhesion of the organic film 34 and the high density of the hydrophobic functional group can further improve the mechanical strength of the magnetic powder core.

In addition, the ceramic preferably contains a silicon oxide or an aluminum oxide.

A silicon oxide or an aluminum oxide have particularly good insulating property and chemical stability, and they are also readily available. As such, by using the ceramic containing these constituent components, the resulting inorganic insulating film 32 has good insulating property over a long period of time.

In addition, the inorganic insulating film 32 may include ceramic particles that are smaller than the soft magnetic particle 2 (a particle of the soft magnetic powder) and that are composed of the ceramic.

Thereby, the ceramic particles can be distributed covering the surface of the soft magnetic particle 2. As a result, the inorganic insulating film 32 that is dense and has a sufficient film thickness can be easily obtained. Such inorganic insulating film 32 has particularly high insulating property.

The average thickness of the organic film 34 is preferably smaller than the average thickness of the inorganic insulating film 32. This makes the organic film 34 a monomolecular film or a molecular film close to a monomolecular film, sufficiently reducing the occupancy of the organic film 34 in the insulator-coated soft magnetic powder 1 while ensuring the moisture resistance derived from the hydrophobic functional group. As such, the resulting magnetic powder core has high magnetic properties.

In addition, the hydrophobic functional group may be a linear alkyl group having from 1 to 6 carbons.

This makes it possible to impart particularly high moisture resistance to the organic film 34.

The hydrophobic functional group may be a cyclic structure-containing group, a fluoroalkyl group, or a fluoroaryl group.

This makes it possible to impart particularly high moisture resistance to the organic film 34. In addition, the cyclic structure-containing group having a cyclic structure and the fluoroaryl group have high stability, and thus good moisture resistance can be maintained even after heating. In addition, in a fluoroalkyl group having a fluorine atom or a fluoroaryl group having a fluorine atom, surface tension resulting from the fluorine atom is low, and thus hydrophobicity excellent. As a result, good moisture resistance can be achieved even after heating. Therefore, the insulator-coated soft magnetic powder 1 with excellent flowability and good filling property during compacting can be obtained even in a humid environment.

The magnetic powder core according to the embodiment includes the insulator-coated soft magnetic powder according to the embodiment. As such, the resulting magnetic powder core has high withstand voltage, high mechanical strength, and high relative density.

The magnetic element according to the embodiment includes the magnetic powder core according to the embodiment. As such, the resulting magnetic powder core has high withstand voltage and high permeability.

The electronic device according to the embodiment includes the magnetic element according to the embodiment. As such, the resulting electronic device has high performance and is downsized.

The insulator-coated soft magnetic powder, the magnetic powder core, the magnetic element, and the electronic device of the present disclosure have been described above based on the preferred embodiment, but the present disclosure is not limited to the embodiment.

For example, in the embodiment above, the magnetic powder core has been described as an application example of the insulator-coated soft magnetic powder of the present disclosure, but application examples are not limited to the described application example, and may be a magnetic device such as a magnetic fluid, a magnetic head, or a magnetic shielding sheet. In addition, the shapes of the magnetic powder core and the magnetic element are not limited to those illustrated in the drawings and may be any shape.

Moreover, the magnetic powder core and magnetic element according to the present disclosure may have any component added to the embodiment above.

### EXAMPLE

Next, specific examples of the present disclosure will be described.

### 6. Preparation of Insulator-Coated Soft Magnetic Powder

### 6.1. Sample No. 1

First, a soft magnetic powder composed of a soft magnetic material listed in Table 1 was prepared. The composition of the soft magnetic material and the method for producing the soft magnetic powder are listed in Table 1. Note that the composition formulas listed in Table 1 represent the atomic ratio of each element. Moreover, the average particle size of the soft magnetic powder is as presented in Table 2.

Next, an inorganic insulating film was formed at the particle surface of the soft magnetic powder. The constituent material of the inorganic insulating film, the average thickness, and the average particle size of the ceramic particles used are as listed in Table 2. A mechanochemical reaction device was used to form the inorganic insulating film.

Next, an organic film was formed at the surface of the inorganic insulating film. The hydrophobic functional group of the coupling agent used to form the organic film, the number of carbons when the hydrophobic functional group is an alkyl group, and the ratio of the average thickness are as listed in Table 2.

The insulator-coated soft magnetic powder of Sample No. 1 was prepared as described above. Thereafter, the water content of the prepared insulator-coated soft magnetic powder was measured. The measurement results are as listed in Table 2.

### 6.2. Samples No. 2 to 40

The insulator-coated soft magnetic powders of Samples No. 2 to 40 were prepared in the same manner as in Sample No. 1 except that the composition of the insulator-coated soft magnetic powder was changed to those listed in Tables 1 to 3.

TABLE 1

| Soft | | |
|---|---|---|
| Magnetic | | Production |
| Material | Composition Formula | Method |
| Crystalline | Fe_{88.6}Si_{6.7}Cr_{4.7} | Water Atomization |
| Material 1 | | |
| Crystalline | Fe_{84.7}Si_{9.4}Al_{5.9} | Water Atomization |
| Material 2 | | |
| Amorphous | (Fe_{0.97}Cr_{0.03})₇₆(Si_{0.5}B_{0.5})₂₂C₂ | Water Atomization |
| Material 1 | | |
| Amorphous | (Fe_{0.97}Cr_{0.03})₇₆(Si_{0.5}B_{0.5})₂₂C₂ | Rotary Water Jet |
| Material 2 | | Atomization |

Note that, in Tables 2 and 3 presented later, among the insulator-coated soft magnetic powders of the sample numbers, those that correspond to the present disclosure are referred to as “Examples”, and those that do not correspond to the present disclosure are referred to as “Comparative Examples”.

Furthermore, the symbols in the chemical formulas listed in Tables 2 and 3 correspond to the following compounds.
A-1: Phenyltrimethoxysilane
B-1: Trimethoxy (3, 3,3-trifluoropropyl) silane
C-1: Trimethoxy (11-pentafluorophenoxyundecyl) silane
D-1: Methyltrimethoxysilane
D-2: Ethyltrimethoxysilane
D-3: Propyltrimethoxysilane
D-4: Hexyltrimethoxysilane
D-5: Octyltrimethoxysilane

### 7. Evaluation of Insulator-Coated Soft Magnetic Powder

### 7.1. DC Insulation Breakdown Voltage (Withstand Voltage)

First, an exposure test was performed. The insulator-coated soft magnetic powders were each left in a high-humidity environment of atmospheric pressure, a temperature of 30° C., and a relative humidity of 80% for 24 hours.

Next, for each insulator-coated soft magnetic powder subjected to the exposure test, the DC insulation breakdown voltage at a room temperature of 25° C. and a relative humidity of 45% was measured by the following method.

First, 0.15 g of insulator-coated soft magnetic powder was filled in an alumina cylinder having an 8 mm inside diameter, and brass electrodes were disposed at both ends of the cylinder. Thereafter, a DC voltage of 50 V was applied between the electrodes for 2 seconds while a force of 20 kgf was applied to the insulator-coated soft magnetic powder by the electrodes at both ends of the cylinder by using a digital force gauge, and an electric resistance value between the electrodes was measured with a digital multimeter.

Next, the DC voltage applied between the electrodes was increased by 50 V at a time. The electric resistance value between the electrodes was measured each time, and the presence of dielectric breakdown was checked. The voltage increase and the measurement of the electric resistance value were repeated until dielectric breakdown occurred. Then, the lowest DC voltage at which dielectric breakdown occurred was obtained. Note that a state in which the electrical resistance value was 1 MQ or less was regarded as dielectric breakdown. The above measurement was carried out three times, and the average value of the measured values was taken as the DC insulation breakdown voltage. Then, the obtained DC insulation breakdown voltage (withstand voltage) was evaluated based on the following evaluation criteria. The evaluation results are presented in Tables 2 and 3.
A: A withstand voltage of 400 V or greater
B: A withstand voltage of 350 V or greater and less than 400 V
C: A withstand voltage of 300 V or greater and less than 350 V
D: A withstand voltage of 250 V or greater and less than 300 V
E: A withstand voltage of 200 V or greater and less than 250 V
F: A withstand voltage of less than 200 V

### 7.2. Radial Crushing Strength of Molded Article

First, an exposure test was performed. The insulator-coated soft magnetic powders were each left in a high-humidity environment of atmospheric pressure, a temperature of 30° C., and a relative humidity of 80% for 24 hours.

Next, each insulator-coated soft magnetic powder subjected to the exposure test was mixed with an epoxy resin serving as a binder and toluene serving as an organic solvent, resulting in a mixture. Note that, the amount of epoxy resin added was 2 parts by mass per 100 parts by mass of the insulator-coated soft magnetic powder.

Next, the resulting mixture was stirred and then dried at 50° C. for 1 hour in an air atmosphere, resulting in a dried mass. Next, the dried mass was passed through a sieve having an opening of 400 μm to pulverize the dried mass, resulting in a granulated powder.

Next, the resulting granulated powder was filled in a molding die, and a green compact was obtained based on the following molding conditions.
Molding method: press molding
Shape of molded article: ring shape.
Dimensions of molded article: outer diameter φ 14 mm, inner diameter φ 8 mm, thickness 3 mm
Molding force: 3 t/cm² (294.2 MPa)

Next, the green compact was heated at 150° C. for 3 hours in an air atmosphere to cure the binder. This resulted in a ring-shaped molded article.

Next, the radial crushing strength of the resulting molded article was measured in accordance with the radial crushing strength test method specified in JIS Z 2507:2000. Specifically, the radial crushing strength K was calculated by K=F (D−t)/(Lt²), where K was the radial crushing strength, D was the outer diameter, t was the thickness in the radial direction (half of the difference between the outer diameter and the inner diameter), L was the thickness, and F was the breaking load. The calculated radial crushing strength was evaluated based on the following evaluation criteria. The evaluation results are presented in Tables 2 and 3.
A: A radial crushing strength of 50 MPa or greater
B: A radial crushing strength of 45 MPa or greater and less than 50 MPa
C: A radial crushing strength of 40 MPa or greater and less than 45 MPa
D: A radial crushing strength of 35 MPa or greater and less than 40 MPa
E: A radial crushing strength of 30 MPa or greater and less than 35 MPa
F: A radial crushing strength of less than 30 MPa

### 7.3. Relative Density of Molded Article

First, an exposure test was performed. The insulator-coated soft magnetic powders were each left in a high-humidity environment of atmospheric pressure, a temperature of 30° C., and a relative humidity of 80% for 24 hours.

Next, the insulator-coated soft magnetic powders subjected to the exposure test were each molded by the same method described in 7.2, resulting in molded articles. Next, the densities of the molded articles were measured. Next, the densities of the molded articles were divided by the true densities of the soft magnetic powders to calculate the relative densities. The calculated relative densities were evaluated based on the following evaluation criteria. The evaluation results are presented in Tables 2 and 3.
A: A relative density of 67% or greater
B: A relative density of 66% or greater and less than 67%
C: A relative density of 65% or greater and less than 66%
D: A relative density of 64% or greater and less than 65%
E: A relative density of 63% or greater and less than 64%
F: A relative density of less than 63%

TABLE 2

| | | Composition of Insulator-Coated Soft Magnetic Powder | | | | | | | |
|---|---|---|---|---|---|---|---|---|---|
| | | | | Inorganic Insulating Film | | | | | |
| | | | | | | Ratio of | | | |
| | | | | | | Average | | | |
| | | | | | | Thickness | | | |
| | | Soft Magnetic | | | | to Particle | Average | | |
| | | Powder | | | | Size of | Particle | Organic Film | |
| | | Soft | Average | Constit- | | Soft | Size of | Hydrophobic | |
| | | Magnetic | Particle | uent | Average | Magnetic | Ceramic | Functional | Chemical |
| Sample | Catego- | Material | Size | Material | Thickness | Material | Particles | group | Formula |
| No. | rization | — | μm | — | nm | % | nm | — | — |
| 1 | Example | Crystalline | 10 | Silicon | 5 | 0.05 | 5 | Alkyl Group | D-1 |
| | | Material 1 | | Oxide | | | | | |
| 2 | Example | Crystalline | 10 | Silicon | 20 | 0.20 | 5 | Alkyl Group | D-1 |
| | | Material 1 | | Oxide | | | | | |
| 3 | Example | Crystalline | 5 | Silicon | 60 | 1.20 | 5 | Alkyl Group | D-1 |
| | | Material 2 | | Oxide | | | | | |
| 4 | Example | Crystalline | 10 | Silicon | 80 | 0.80 | 5 | Alkyl Group | D-1 |
| | | Material 1 | | Oxide | | | | | |
| 5 | Example | Crystalline | 10 | Silicon | 30 | 0.30 | 5 | Alkyl Group | D-3 |
| | | Material 1 | | Oxide | | | | | |
| 6 | Example | Crystalline | 10 | Silicon | 40 | 0.40 | 5 | Alkyl Group | D-4 |
| | | Material 1 | | Oxide | | | | | |
| 7 | Example | Crystalline | 10 | Silicon | 50 | 0.50 | 5 | Alkyl Group | D-5 |
| | | Material 1 | | Oxide | | | | | |
| 8 | Example | Crystalline | 20 | Silicon | 100 | 0.50 | 5 | Alkyl Group | D-2 |
| | | Material 2 | | Oxide | | | | | |
| 9 | Example | Crystalline | 5 | Silicon | 5 | 0.10 | 5 | Alkyl Group | D-1 |
| | | Material 2 | | Oxide | | | | | |
| 10 | Example | Crystalline | 10 | Silicon | 50 | 0.50 | — | Alkyl Group | D-1 |
| | | Material 1 | | Oxide | | | | | |
| 11 | Example | Crystalline | 10 | Silicon | 70 | 0.70 | 5 | Phenyl Group | A-1 |
| | | Material 1 | | oxide | | | | | |
| 12 | Example | Crystalline | 10 | Silicon | 70 | 0.70 | 5 | Fluoroalkyl | B-1 |
| | | Material 1 | | Oxide | | | | Group | |
| 13 | Example | Crystalline | 10 | Silicon | 70 | 0.70 | 5 | Fluorophenyl | C-1 |
| | | Material 1 | | Oxide | | | | Group | |
| 14 | Example | Crystalline | 10 | Aluminum | 10 | 0.10 | 10 | Alkyl Group | D-3 |
| | | Material 1 | | Oxide | | | | | |
| 15 | Example | Crystalline | 10 | Aluminum | 40 | 0.40 | 10 | Phenyl Group | A-1 |
| | | Material 1 | | Oxide | | | | | |
| 16 | Example | Crystalline | 20 | Phosphate | 80 | 0.40 | 20 | Phenyl Group | A-1 |
| | | Material 2 | | Glass | | | | | |
| 17 | Example | Crystalline | 20 | Phosphate | 80 | 0.40 | 20 | Alkyl Group | D-4 |
| | | Material 2 | | Glass | | | | | |
| 18 | Comparative | Crystalline | 10 | Silicon | 50 | 0.50 | 5 | — | — |
| | Example | Material 1 | | Oxide | | | | | |
| 19 | Comparative | Crystalline | 10 | None | — | — | — | Alkyl Group | D-1 |
| | Example | Material 1 | | | | | | | |
| 20 | Comparative | Crystalline | 10 | Silicon | 2 | 0.02 | 5 | Alkyl Group | D-1 |
| | Example | Material 1 | | Oxide | | | | | |
| 21 | Comparative | Crystalline | 20 | Silicon | 200 | 1.00 | 5 | Alkyl Group | D-1 |
| | Example | Material 2 | | Oxide | | | | | |
| 22 | Comparative | Crystalline | 20 | Aluminum | 100 | 0.50 | 5 | Alkyl Group | D-4 |
| | Example | Material 2 | | Oxide | | | | | |
| 23 | Comparative | Crystalline | 10 | Aluminum | 40 | 0.40 | 10 | — | — |
| | Example | Material 1 | | Oxide | | | | | |
| 24 | Comparative | Crystalline | 10 | None | — | — | — | Alkyl Group | D-1 |
| | Example | Material 1 | | | | | | | |

| | Composition of Insulator-Coated Soft Magnetic Powder | | | | | |
|---|---|---|---|---|---|---|
| | Organic Film | | | | | |
| | | Ratio of | | | | |
| | | Average | | | | |
| | Number of | Thickness to | | Evaluation Result | | |
| | Carbons | Inorganic | | | Radial | |
| | in Alkyl | Insulating | Water | Withstand | Crushing | Relative |
| Sample | Group | Film | Content | Voltage | Strength | Density |
| No. | — | % | ppm | — | — | — |
| 1 | 1 | 90 | 70 | B | A | B |
| 2 | 1 | 23 | 100 | A | A | A |
| 3 | 1 | 8 | 200 | A | B | B |
| 4 | 1 | 6 | 300 | A | B | B |
| 5 | 3 | 15 | 80 | A | A | A |
| 6 | 6 | 11 | 50 | A | B | B |
| 7 | 8 | 9 | 50 | A | C | C |
| 8 | 2 | 5 | 380 | A | C | C |
| 9 | 1 | 90 | 250 | B | C | C |
| 10 | 1 | 9 | 250 | B | B | B |
| 11 | — | 6 | 50 | A | A | A |
| 12 | — | 6 | 40 | A | A | A |
| 13 | — | 6 | 30 | A | A | A |
| 14 | 3 | 45 | 30 | B | B | B |
| 15 | — | 11 | 80 | A | A | A |
| 16 | — | 6 | 150 | B | A | A |
| 17 | 6 | 6 | 250 | C | C | C |
| 18 | — | — | 1000 | E | F | F |
| 19 | 1 | — | 10 | F | A | A |
| 20 | 1 | 225 | 100 | D | B | B |
| 21 | 1 | 2 | 400 | D | D | D |
| 22 | 6 | 5 | 500 | D | C | E |
| 23 | — | — | 800 | E | F | F |
| 24 | 1 | — | 10 | F | A | A |

TABLE 3

| | | Composition of Insulator-Coated Soft Magnetic Powder | | | | | | | |
|---|---|---|---|---|---|---|---|---|---|
| | | | | Inorganic Insulating Film | | | | | |
| | | | | | | Ratio of | | | |
| | | | | | | Average | | | |
| | | | | | | Thickness | | | |
| | | Soft Magnetic | | | | to Particle | Average | | |
| | | Powder | | | | Size of | Particle | Organic Film | |
| | | Soft | Average | Constit- | | Soft | Size of | Hydrophobic | |
| | | Magnetic | Particle | uent | Average | Magnetic | Ceramic | Functional | Chemical |
| Sample | Catego- | Material | Size | Material | Thickness | Material | Particles | group | Formula |
| No. | rization | — | μm | — | nm | % | nm | — | — |
| 25 | Example | Amorphous | 3 | Silicon | 5 | 0.17 | 5 | Alkyl Group | D-1 |
| | | Material 1 | | Oxide | | | | | |
| 26 | Example | Amorphous | 8 | Silicon | 30 | 0.38 | 5 | Alkyl Group | D-1 |
| | | Material 2 | | Oxide | | | | | |
| 27 | Example | Amorphous | 3 | Silicon | 20 | 0.67 | 5 | Alkyl Group | D-1 |
| | | Material 1 | | Oxide | | | | | |
| 28 | Example | Amorphous | 8 | Silicon | 60 | 0.75 | 5 | Alkyl Group | D-1 |
| | | Material 2 | | Oxide | | | | | |
| 29 | Example | Amorphous | 3 | Silicon | 20 | 0.67 | 5 | Alkyl Group | D-3 |
| | | Material 1 | | Oxide | | | | | |
| 30 | Example | Amorphous | 3 | Silicon | 40 | 1.33 | 5 | Alkyl Group | D-4 |
| | | Material 1 | | Oxide | | | | | |
| 31 | Example | Amorphous | 3 | Silicon | 30 | 1.00 | 5 | Phenyl Group | A-1 |
| | | Material 1 | | Oxide | | | | | |
| 32 | Example | Amorphous | 3 | Aluminum | 10 | 0.33 | 10 | Alkyl Group | D-3 |
| | | Material 1 | | Oxide | | | | | |
| 33 | Example | Amorphous | 8 | Aluminum | 40 | 0.50 | 10 | Phenyl Group | A-1 |
| | | Material 2 | | Oxide | | | | | |
| 34 | Comparative | Amorphous | 3 | Silicon | 50 | 1.67 | 5 | — | — |
| | Example | Material 1 | | Oxide | | | | | |
| 35 | Comparative | Amorphous | 3 | None | — | — | — | Alkyl Group | D-1 |
| | Example | Material 1 | | | | | | | |
| 36 | Comparative | Amorphous | 3 | Silicon | 1 | 0.03 | 5 | Alkyl Group | D-1 |
| | Example | Material 1 | | Oxide | | | | | |
| 37 | Comparative | Amorphous | 8 | Silicon | 150 | 1.88 | 5 | Alkyl Group | D-1 |
| | Example | Material 2 | | Oxide | | | | | |
| 38 | Comparative | Amorphous | 8 | Aluminum | 100 | 1.25 | 5 | Alkyl Group | D-4 |
| | Example | Material 2 | | Oxide | | | | | |
| 39 | Comparative | Amorphous | 3 | Aluminum | 40 | 1.33 | 10 | — | — |
| | Example | Material 1 | | Oxide | | | | | |
| 40 | Comparative | Amorphous | 3 | None | — | — | — | Alkyl Group | D-1 |
| | Example | Material 1 | | | | | | | |

| | Composition of Insulator-Coated Soft Magnetic Powder | | | | | |
|---|---|---|---|---|---|---|
| | Organic Film | | | | | |
| | | Ratio of | | | | |
| | | Average | | | | |
| | Number of | Thickness to | | Evaluation Result | | |
| | Carbons | Inorganic | | | Radial | |
| | in Alkyl | Insulating | Water | Withstand | Crushing | Relative |
| Sample | Group | Film | Content | Voltage | Strength | Density |
| No. | — | % | ppm | — | — | — |
| 25 | 1 | 90 | 60 | B | B | B |
| 26 | 1 | 15 | 90 | A | A | A |
| 27 | 1 | 23 | 180 | A | A | A |
| 28 | 1 | 8 | 260 | A | B | B |
| 29 | 3 | 23 | 70 | A | A | A |
| 30 | 6 | 11 | 40 | A | B | C |
| 31 | — | 15 | 40 | A | A | A |
| 32 | 3 | 45 | 30 | A | B | B |
| 33 | — | 11 | 70 | A | A | A |
| 34 | — | — | 800 | E | F | F |
| 35 | 1 | — | 10 | F | A | A |
| 36 | 1 | 450 | 100 | E | B | B |
| 37 | 1 | 3 | 300 | D | D | E |
| 38 | 6 | 5 | 500 | D | D | E |
| 39 | — | — | 750 | E | F | F |
| 40 | 1 | — | 10 | F | A | A |

As presented in Table 2 and Table 3, compared to the insulator-coated soft magnetic powders of Comparative Examples, the insulator-coated soft magnetic powders of Examples had good withstand voltage, high radial crushing strength of the molded articles, and high relative density of the molded articles even after exposure to a humid environment.

Meanwhile, it was found that when the insulating coating film was only an inorganic insulating film or only an organic film, either the withstand voltage or the radial crushing strength plus the relative density decreased. It was also found that the thickness or water content of the inorganic insulating film was important for improving the withstand voltage or radial crushing strength plus the relative density.

The above results indicate that the present disclosure yields an insulator-coated soft magnetic powder that has excellent moisture resistance and in which a decrease in insulating property and flowability due to moisture absorption is suppressed.

What is claimed is:

1. An insulator-coated soft magnetic powder, comprising:
a soft magnetic powder;
an inorganic insulating film including a ceramic and covering the particle surface of the soft magnetic powder; and
an organic film including a compound derived from a coupling agent having a hydrophobic functional group and covering the surface of the inorganic insulating film, wherein
the inorganic insulating film has an average thickness of from 5 nm to 100 nm, and
the insulator-coated soft magnetic powder has a water content of from 30 ppm to 400 ppm, as measured by the Karl Fischer method at 250° C. after the insulator-coated soft magnetic powder is left in an environment of atmospheric pressure, a temperature of 30° C., and a relative humidity of 80% for 24 hours.

2. The insulator-coated soft magnetic powder according to claim 1, wherein the ceramic comprises a silicon oxide or an aluminum oxide.

3. The insulator-coated soft magnetic powder according to claim 1, wherein the inorganic insulating film comprises ceramic particles that are smaller than particles of the soft magnetic powder and that are composed of the ceramic.

4. The insulator-coated soft magnetic powder according to claim 1, wherein the organic film has an average thickness that is smaller than the average thickness of the inorganic insulating film.

5. The insulator-coated soft magnetic powder according to claim 1, wherein the hydrophobic functional group is a linear alkyl group having from 1 to 6 carbons.

6. The insulator-coated soft magnetic powder according to claim 1, wherein the hydrophobic functional group is a cyclic structure-containing group, a fluoroalkyl group, or a fluoroaryl group.

7. A magnetic powder core comprising the insulator-coated soft magnetic powder according to claim 1.

8. A magnetic element comprising the magnetic powder core according to claim 7.

9. An electronic device comprising the magnetic element according to claim 8.
